(19) United States
(12) Patent Application Publication
(10) Pub. No.: US 2018/0043245 A1
(43) Pub. Date: Feb. 15, 2018

(54) Simulation System for Balance Control in Interactive Motion

(71) Applicant: Yuanfeng Zhu, San Jose, CA (US)

(72) Inventor: Yuanfeng Zhu, San Jose, CA (US)

(21) Appl. No.: 15/168,253

(22) Filed: Aug. 10, 2016

(51) Int. Cl. A63F 13/211; A63F 13/65

(52) U.S. Cl. CPC A63F 13/211; A63F 13/65; A63F 2300/8082

(57) ABSTRACT

Action games and animation movies require engaging character interaction with other characters and/or objects in dynamic environment, which lead to many possible responsive motions. However, it remains di cult to simulate diverse balanced interactive motion in dynamic system, which are widely determined by physics laws related to collision, balance control, bio-mechanics constraints, un-expected external forces such as a hit to any body part from the opponent character, following a user-required motion goal. A simulation system to achieve this research goal is provided in this documentation.

The input of this system is, given the current motion state such as a state after an hit from the opponent, a reasonable responsive motion goal required by the action director such as to give a counter-strike punch to the opponent head while decaying the energy of the hit to keep balance. The output is goal-directed balanced motion driven by joint torques in dynamic virtual environment.

The significant contribution is two proposed Lyapunov-Function-based constraints, which are used in the proposed optimization framework to find the optimal motion strategy which achieves the responsive motion goal while keeping balance. The first advantage of this system is to use the first Lyapunov-Function-based constraint to more quickly converge the optimization progress by eliminating massive candidate strategies unworkable to achieve the motion goal, rather than to test each candidate strategy by a traditional way based on dynamic forward simulation which require much more computation resources especially on time. The second advantage is to use the second Lyapunov-Function-based constraint to more quickly and more precisely judge the current balance state of motion and then employ it to predict the future balance state under control of the current motion controller.

In sum, our system would be unique to generate diverse balanced responsive fighting motion for action game and movies in a much more efficient manner. Namely the action designer are only required to provide an responsive motion goal (including objective action pose and timing information) like an action director in action movie, and then the system will automatically generate the controllable and balanced dynamics responsive fighting motion driven by joint torques, and motion capture data is not needed.

### BACKGROUND

When a character interacts with the full-dynamic environment in visual world, many unexpected factors will influence character's motion, which are widely determined by physics laws related to collision and balance control, bio-mechanics constraints, un-expected external forces such as a hit from another character, user-required motion goal such as to give a counter-strike punch to the head. On the other hand, based on the role of a character in the scenario, given diversity of the un-certainty mentioned above, a character might have several special action skills to choose for a responsive motion. It's why animating such diverse responsive behaviors of characters for action games and animation movies remains a challenge work even for professional animation artists, who usually achieve this task primarily through key-framing and/or blending with motion capture sequences.

### SUMMARY OF THE INVENTION

### 1. Contribution and Claims

Unlike the previous full-dynamic-based solution, which solves the balance problem of responsive motion within a certain type of motion such as from walking to stepping or running, the challenge of our research is to generate various physics-valid balanced responsive motion, even if no motion capture data is tracked and/or even the animator-designed motion which human cannot achieve.

To our best knowledge, this application goal has not been achieved by such an automatic approach in all the previous research work, and is only manually achievable by experienced animators, which is quite a low-efficient way to generate a high-quality motion clip. It is first because usually many joints need to be regulated due to the multi-actuated human joint hierarchy; secondly, the motion curves generated between the key frames are usually not physicsplausible ones and need much more carefully regulation; thirdly, the more complex motion, the more key frames should be inserted to make sure every significant posture is correctly make in the right place and right time.

Since no existing work can achieve our research goal, and therefore we have the following claim: Claim 1: A simulation system is provided to generate diverse responsive motions in a full-dynamic environment while not being constrained by the scale of the motion capture database or even with no motion data supports. When an avatar in the system is hit by another, the system halts and asks animator to create a motion goal including a desired time to achieve the goal, a desired pose, and a desired motion strategy which is selected from a provided motion database. After the motion goal is set, an optimization framework is provided to find optimal solution to achieve such a goal while keeping avatar's motion balance after achievement of the motion goal.

Before we extend the discussion, some important notations in this paper is first defined as follows:
Disturbance described as d in the proposed system, it is an external force which can influence character's well-ordered existing motion state. For instance, in the fighting gaming or movie, a disturbance could be a hit to the character by a punch, a kick or other hit caused by a weapon.
Control strategy described as Sᵢ={Pⱼ}, where each Pⱼ represents a activated joint controller to drive joint rotation, is a combination of individual activated joint controllers to achieve a certain motion skill. For instance, given the hit mentioned in FIG. 1, each sub-image in FIG. 2, FIG. 3, FIG. 4 and FIG. 5 corresponds to a key posture generated by a certain control strategy. Further, a control strategy, such as the one mentioned in the third sub-image of FIG. 5, manages rotations for joints including two shoulders, right upper leg and right knee.
Motion control strategy database described as S in the proposed system, is a database in which each element is a different control strategy to generate a motion skill

For example, given a normal standing state and a hit d to the character's upper body as shown in FIG. 1, a key posture of responsive motion generated by a certain control strategy Sᵢ is shown in each sub-image in FIG. 2, FIG. 3, FIG. 4 and FIG. 5. If the role of the character is a fighter, the animator might require it to make a counter-strike responsive motion controlled by an Sᵢ chosen from control strategy set S={Sᵢ} composed of: the last sub-image in FIG. 2, first two sub-images in FIG. 3, and all sub-images in FIG. 4 and FIG. 5. If the character acts just as a normal human, he might be required to make a reaction chosen from a control strategy Sᵢ composed of the first two sub-images in FIG. 2 and last two sub-images in FIG. 3

Therefore, a robust controller is desired to generate various reasonable responsive motions based on the un-expected factors and the role to act in the scenario.

FIG. 1 illustrates an initial posture before a hit to the upper body. The green arrow shows the external force to the upper body.

FIG. 2 illustrates three different standing control strategies. The strategies are respectively: balanced standing with bending spine joint backward only; balanced standing with bending spine joint backward more and lifting two arms up; balanced standing with bending spine joint backward a little with bonding two arms up.

FIG. 3 illustrates three different stepping control strategies. The strategies are respectively: balanced stepping back with bending spine backward and upper arm up (prepared to give a boxing attack); balanced stepping back with keeping right leg straight, bending spine backward more, and swinging the whole arms up; balanced stepping back with keeping right leg bend, bending spine backward much more, and swinging the whole arms up.

FIG. 4 illustrates two different rotating control strategies. The strategies are respectively: balanced rotating spine along vertical axis with left leg stepping back, left arm swinging back along vertical axis, and right arm swinging forward to give an attack; balanced rotating spine along vertical axis with left leg stepping back, left arm swinging back along vertical axis with left forearm bending down, and right arm swinging forward to give an attack with left forearm bending up.

FIG. 5 illustrates three different jumping control strategies. The strategies are respectively: Right leg is used to jump up, with bending spine backward, swinging two arms backward; Two legs are used to jump back to rotate the whole body horizontal, with swinging two arms backward; One leg is used to jump back to rotate the whole body horizontal, with swinging two arms backward.

Our research goal is to provide a solution to solve this problem in dynamics-based simulation on the following two significant aspects:

1) To more quickly find the candidate control solution to achieve the objective action pose with an exact timing requirement.

2) Rather than to employ the traditional static-balance approach (COM and/CP based method) to guess the future balance state of the character motion, a novel approach based on dynamic-balance theory is proposed to predict the balance state of the motion based on the current balance state under control of the current motion solution.

Note: the static balance is used to judge whether the current motion is balanced, and the traditional approach based on static balance is to use COM and/CP based method; the dynamic balance is used the judge that given a disturbance to a character, whether the external forces and torques influenced by the disturbance can produce future motion as oscillation about the desired motion. Therefore the dynamic balance-based approach has the ability to predict the future balance state of motion, while the static balance approach does not.

### 2. System Work Flow

Our system works as follows:

Step 1, given a hit to the character at time t, the system will employ the current control strategy for one-step forward full-dynamic simulation at time t+Δt.

Step 2, the system will halt on the current simulation, and waiting for the user to choose a motion goal O from a list of motion goals such a punch to the head. The system can also randomly choose a motion goal without animator interaction if desired. In our current system, O is defined as O={Rᵢ_{_{d}}} where Rᵢ_{_{d}} is the desired rotation for body part i to achieve.

Step 3, based on motion status M_{t+Δt} and the selected motion goal O, a searching method is proposed to automatically compose a candidate control strategy set S_{C} based on the proposed motion control strategy database D. Each candidate control strategy Sᵢ in the set S_{C} is composed of several simple PD controllers (such as stepping legs, swinging legs/arms, rotating spine, boxing punch and so on) from a proposed PD-controller database to drive the joint motion. For example, given a punch to the opponent as a motion goal, the set S_{C} will include various key poses to achieve it.

Step 4, a shell model outside the PD-controller is first designed based on Under-Damped Oscillator theory, and it allows the user to conveniently and meaningfully set the constraints influencing the PD-controller's parameters such as the joint motion's amplitude, damping ratio, oscillating period and initial phase position, which are not supported by previous PD-controllers.

By setting more meaningful parameters of PD-controllers with this new model, it will generally narrow the searching space during the optimization computation in Step 5.

Step 5, based on the initial motion state M_{t+Δt}, and the extracted candidate control strategy set S_{C}, with a proposed Lyapunov-Function-based optimization framework F, the system will filter the optimal motion strategy S_{Opt} which can achieve the motion goal (by default, a motion goal is to achieve the objective motion pose and keep balance before and after the achievement of that pose).

Step 6, the system will resume physics-valid balanced responsive motion using the found optimal motion strategy S_{Opt} to generate a balanced motion which can achieve the objective motion pose.

### 3. An Example to Show System Work Flow

An example where the system can be applied is based on a hit H to a fighter character as mentioned in FIG. 1, control strategy database D composed of control strategies mentioned in each sub-image in FIGS. 2, 3, 4 and 5 respectively.

Assuming that before the hit H, the character has initial standing posture O, controlled by a vertical straight-standing control strategy S₀ which control joint rotations of spine and two upper arms.

When the disturbance H happens, the proposed system will first find the candidate control strategy set S chosen by animator either by a real-time way or a pre-defined way based on the current simulation state.

Then based on the candidate strategy set S and initial motion state O, the system will call optimization framework F for the optimum solution, namely optimal strategy S_{Opt} with parameters value set for the corresponding controller. For instance, the optimal control strategy can be the one mentioned in the third sub-image in FIG. 2, which controls spine joint, shoulder joints and forearm joints to make a boxing preparation motion from initial motion state O toward to a key boxing posture as shown in the third sub-image in FIG. 2.

Finally, the proposed system will resume forward simulation using the optimal control strategy with the optimal control values.

### BRIEF DESCRIPTION OF THE DRAWINGS

For a more complete understanding of the invention, reference is made to the following description and accompanying drawings, in which:

FIG. 1: An initial posture before a hit to the upper body. The green arrow shows the external force to the upper body.

FIG. 2: Three different standing control strategies. The strategies are respectively: balanced standing with bending spine joint backward only; balanced standing with bending spine joint backward more and lifting two arms up; balanced standing with bending spine joint backward a little with bending two arms up.

FIG. 3: Three different stepping control strategies. The strategies are respectively: balanced stepping back with bending spine backward and upper arm up (prepared to give a boxing attack); balanced stepping back with keeping right leg straight, bending spine backward more, and swinging the whole arms up; balanced stepping back with keeping right leg bend, bending spine backward much more, and swinging the whole arms up.

FIG. 4: Two different rotating control strategies. The strategies are respectively: balanced rotating spine along vertical axis with left leg stepping back, left arm swinging back along vertical axis, and right arm swinging forward to give an attack; balanced rotating spine along vertical axis with left leg stepping back, left arm swinging back along vertical axis with left forearm bending down, and right arm swinging forward to give an attack with left forearm bending up.

FIG. 5: Three different jumping control strategies. The strategies are respectively: Right leg is used to jump up, with bending spine backward, swinging two arms backward; Two legs are used to jump back to rotate the whole body horizontal, with swinging two arms backward; One leg is used to jump back to rotate the whole body horizontal, with swinging two arms backward.

FIG. 6: The type of oscillation is decided by the values of ζ.

FIG. 7: Motion curve of COM point driven by a simple standing balance controller with three activated joints on two shoulders and torso without disturbance. Its initial and desired pose is the same as FIG. 12 shows.

FIG. 8: Motion curve of COM point driven by a simple standing balance controller with three activated joints on two shoulders and torso with disturbance. ts initial and desired pose is as the right picture of FIG. 12 shows.

FIG. 9: Motion curve of COM point driven by a walking balance controller without being attacked.

FIG. 10 Motion curve of COM point driven by a walking balance controller under attack.

FIG. 11 Motion curve of COM point driven by a simple jumping balance controller with three activated joints on two shoulders and torso.

FIG. 12: Standing balance: the left picture shows its initial pose, and the right picture shows its finally position after the joint controllers decay the motion energy. The circle on the ground is the foot support area.

FIG. 13: A motion curve to show the trajectory of the COM point along Axis X during balanced stranding. The COM point finally stops at the desired position whose translation component along the Axis Z stops at around −0.02 m, the desired position is at 0.0 m.

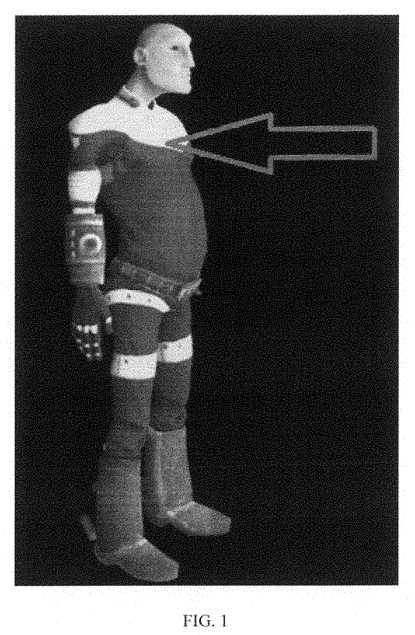

### DETAILED DESCRIPTION

The following are the general introduction of this chapter.

Section 1 describes the design of the motion database, each element of which is a combination of several joint PD-controllers to achieve one motion skill (Several skills such as locomotion, balance standing and jumping controller are implemented).

Section 2 describes the design of the optimization framework to find an optimum solution to achieve the motion goal.

### 1. Design of Motion Database

Claim 2: The simulation system in Claim 1, wherein the motion database includes both a PD-controller database providing the basic joint PD controllers to drive the rotations of body parts, and a motion strategy database, each element of which is a motion strategy composed of several simple PD-controllers from PD controller database to achieve a certain human motion such as a punch, locomotion, a jump or balanced standing.

A motion strategy database is supposed to provide the various candidate responsive motion solutions for our proposed optimization framework to find an optimal one while satisfying various constraints. Therefore our strategy database should include as many motion controllers as possible to support more types of human motion.

Also, the indispensable and novel component of our system is to construct two Lyaponuv-function based constraints to more quickly find a balance controller to achieve the objective motion with an exact timing requirement, but it is di cult to construct a working Lyaponuv function on dynamic equations which are widely decided by a set of body joint motion controllers, gravity, ground reaction, and un-expected disturbance. Therefore the controllers should be carefully designed to make sure a certain Lyaponuv function can be constructed while still describing the features of human motion plausibly.

Based on the above two important requirements, specific PD-controllers can be used to drive the joint motion (namely rotation). Firstly the solutions (equation for joint orientation) of PD controllers have their first-order derivative which satisfies the basic requirement for Lyaponuv Function to evaluate the stability of whole body motion. Secondly PD-controllers are widely used to drive human joint motion in the physics-reality simulation.

Therefore, in the rest of this section, we will first introduce the PD-controller database, which provides the basic joint PD controllers to drive a certain part rotations. Secondly, a motion strategy database is designed, and each motion strategy in this database combines several simple PD-controllers from PD controller database to achieve a certain human motion such as a punch, locomotion, a jump or balanced standing.

### 1.1 Design of PD-Controller Database

Claim 3: The motion database in Claim 2, wherein the PD-controller database include 14 elements for totally 14 joints (namely torso, lHip, rHip, head, lShoulder, rShoulder, lKnee, rKnee, lElbow, rElbow, lAnkle, rAnkle, lToe, and rToe), and each element of this database is a joint PD controllers to drive the rotation of corresponding body part.

PD Controller is short for Proportional-Derivative Controller, which is widely used to generate joint torque to drive the body motion. It is a special condition when a PID Controller (Proportional-Integral-Derivative controller) does not has its integral item.

In this system, each PD controller to generate torque Tᵢ(t) for Body i at time t is formulated as:

Tᵢ(t)=−Kpᵢ*(Rᵢ(t)−Rᵢ_{_{d}})−Kdᵢ*(Rᵢ(t)−\dot{R}ᵢ_{_{d}})

Where Kpᵢ is the spring coefficient of PD controller of Joint i, Kdᵢ is the damping coefficient, Rᵢ(t) is the joint orientation at Time t, Rᵢ_{_{d}} is desired joint orientation to achieve the motion goal, (\dot{R}ᵢ(t) is the angular velocity at Time t, \dot{R}ᵢ_{_{d}} is desired angular velocity to achieve the motion goal.

The designed PD-controller database is constructed to provide parameters for 14 PD controllers of 14 joints namely torso, lHip, rHip, head, lShoulder, rShoulder, lKnee, rKnee, lElbow, rElbow, lAnkle, rAnkle, lToe, and rToe. It is designed as Table 1 shows.

For each Component j where j=1, 2 or 3 corresponding to the Axis X, Y and Z in the joint local coordinate system of Joint i:
Property controlled[j]: To set whether the component is activated. If activated, the PD controller will generate joint motion; If not, joint motion is locked at its initial angular position.
Property Kp[j]: To set spring coefficient of PD controller.
Property Kd[j]: To set damping coefficient of PD controller.
Property x_{d}[j]: To set the desired angular position of joint motion.
Property v_{d}[j]: To set the desired angular velocity of joint motion.
Property KpUp[j]: To set upper bound of spring coefficient of PD controller.
Property KpLow[j]: To set lower bound of spring coefficient of PD controller.
Property KdUp[j]: To set upper bound of damping coefficient of PD controller.
Property KdLow[j]: To set lower bound of damping coefficient of PD controller.
Property desiredGP[j]: To set the desired oscillation phase of current joint relative to the oscillation phase of torso joint. This property is used configure the angular position and rotation direction of current joint relative to torso joint when the PD controller follows an under-damped harmonic oscillation style of motion.
Property maxAbsTorque[j]: To set upper bound of max torque generated by the PD controller.

Note: the left and right body parts such as l/rHip have similar property values, and therefore we combine them to one column in this table.

TABLE 1
PD-Controller Database in Our System.

| | | | | 1/ | 1/ | 1/ | 1/ | |
|---|---|---|---|---|---|---|---|---|
| Property | torso | 1/rHip | head | rShoulder | rKnee | rElbow | rAnkle | 1/rToe |
| controlled[0] | 1 | 1 | 1 | 0 | 1 | 1 | 0 | 0 |
| controlled[1] | 0 | 1 | 0 | 1 | 0 | 0 | 0 | 0 |
| controlled[2] | 1 | 0 | 1 | 1 | 0 | 0 | 1 | 1 |
| Kp[0] | 500 | 205 | 55 | 205 | 305 | 305 | 205 | 205 |
| Kp[1] | 500 | 205 | 55 | 200 | 305 | 305 | 204 | 205 |
| Kp[2] | 500 | 205 | 55 | 200 | 305 | 305 | 205 | 205 |
| Kd[0] | 12.0 | 20 | 5.5 | 1.5 | 20 | 20 | 1.5 | 1.5 |
| Kd[1] | 20.5 | 20 | 5.5 | 1.2 | 20 | 20 | 1.5 | 1.5 |
| Kd[2] | 1.5 | 20.5 | 20 | 5.5 | 2 | 20 | 20 | 1.5 |
| χd[0] | 0 | 0 | 0 | 0 | 0 | 0 | 0 | 0 |
| χd[1] | 0 | 0 | 0 | 0 | 0 | 0 | 0 | 0 |
| χd[2] | 0 | 0 | 0 | 0 | 0 | 0 | 0 | 0 |
| νd[0] | 0 | 0 | 0 | 0 | 0 | 0 | 0 | 0 |
| νd[1] | 0 | 0 | 0 | 0 | 0 | 0 | 0 | 0 |
| νd[2] | 0 | 0 | 0 | 0 | 0 | 0 | 0 | 0 |
| KpUp[0] | 1000 | 400 | 100 | 400 | 600 | 600 | 400 | 400 |
| KpUp[1] | 1000 | 400 | 100 | 400 | 600 | 600 | 400 | 400 |
| KpUp[2] | 1000 | 400 | 100 | 400 | 600 | 600 | 400 | 400 |
| KpLow[0] | 300 | 0.1 | 0.1 | 0.3 | 0.5 | 0.1 | 0.1 | 0.1 |
| KpLow[1] | 200 | 0.1 | 0.1 | 0.3 | 0.5 | 0.1 | 0.1 | 0.1 |
| KpLow[2] | 200 | 0.1 | 0.1 | 0.3 | 0.5 | 0.1 | 0.1 | 0.1 |
| KdUp[0] | 30 | 20 | 20 | 20 | 20 | 20 | 20 | 20 |
| KdUp[1] | 30 | 20 | 20 | 20 | 20 | 20 | 20 | 20 |
| KdUp[2] | 30 | 20 | 20 | 20 | 20 | 20 | 20 | 20 |
| KdLow[0] | 0.5 | 0.1 | 0.1 | 0.1 | 0.1 | 0.1 | 0.1 | 0.1 |
| KdLow[1] | 0.5 | 0.1 | 0.1 | 0.1 | 0.1 | 0.1 | 0.1 | 0.1 |
| KdLow[2] | 0.5 | 0.1 | 0.1 | 0.1 | 0.1 | 0.1 | 0.1 | 0.1 |
| desiredGP[0] | 2 | 0 | 0 | 0 | 0 | 0 | 0 | 0 |
| desiredGP[1] | 0 | 0 | 0 | 2 | 0 | 0 | 0 | 0 |
| dcsircdGP[2] | 0 | 0 | 0 | 4 | 0 | 0 | 0 | 0 |
| maxAbsTorque[0] | 10³ | 10³ | 10³ | 10³ | 10³ | 10³ | 10³ | 10³ |
| maxAbsTorque[1] | 10³ | 10³ | 10³ | 10³ | 10³ | 10³ | 10³ | 10³ |
| maxAbsTorque[2] | 10³ | 10³ | 10³ | 10³ | 10³ | 10³ | 10³ | 10³ |

### 1.2 Design of the Motion Strategy Database

Claim 4: The motion database in Claim 2, wherein the strategy database provides 4 basic types of motion strategies (namely standing, locomotion, jumping and punching), and each strategy is composed of several key poses for that motion type, and each key pose is composed of a combination of joint orientations for all 14 joints defined in the provided PD-controller Database claimed in Claim 3.

The motion strategy database is a motion capture database that provides basic reference motion curve to track various motion skills. Instead, motion strategy database includes various dynamic motion controller for various motion skills.

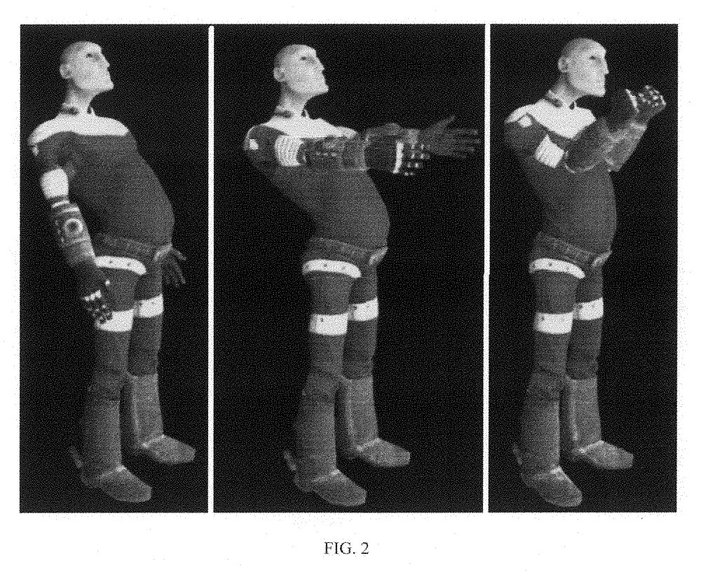

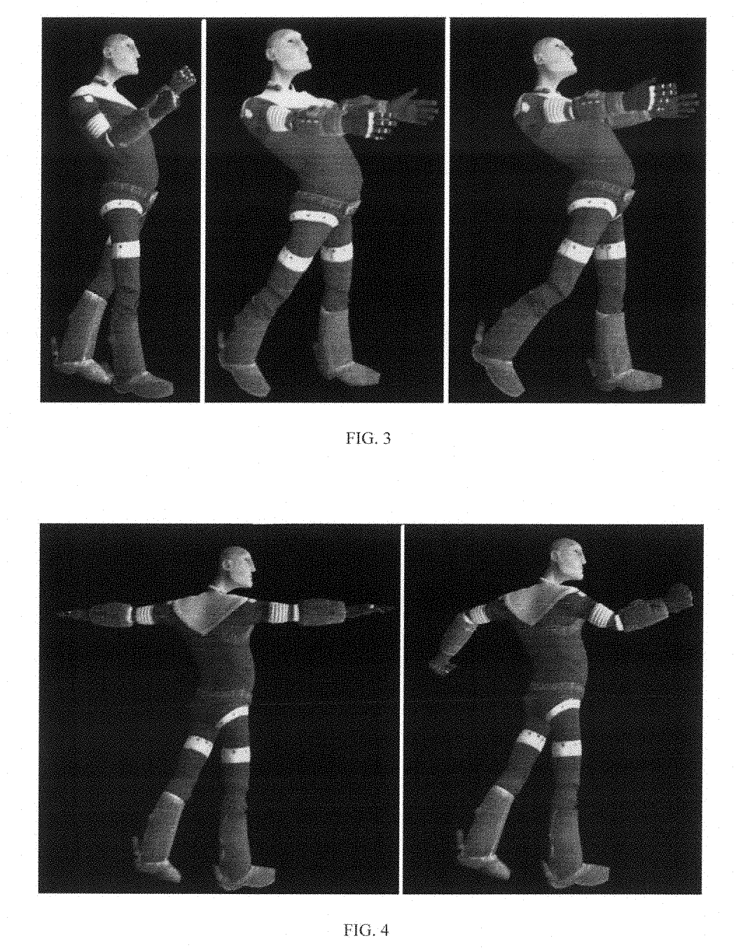

By now, we have got a walking controller, a standing balance controller, a simple jumping controller, and a punch controller described as follows
o Standing Controller: some typical key poses is shown in FIG. 2.
Locomotion Controller: some typical key poses is shown in FIG. 3.
Jumping Controller: some typical key poses is shown in FIG. 5.
Punching Controller: some typical key poses is sharing the third picture of FIG. 2, the first picture of FIG. 3, the first and second pictures of FIG. 4.

### 2. Lyapunov-Function-Based Optimization Framework

Claim 5: The simulation system in Claim 1, wherein the optimization framework, given an initial motion state and the motion goal set by animator, is provided to find the optimal motion strategy to minimize or maximize motion energy cost as its optimization objective under three constraints.

Based on the initial motion state M_{t+Δt}, a desired motion strategy S chosen by animator, a Lyapunov-Function-based optimization framework F is provided with an optimization objective function Obj to find the optimal motion strategy S_{Opt} with its corresponding optimal value set V_{S}_{_{Opt}}

By default, the motion goal for interactive motion include two key points: the first is to start moving to the desired action pose at the desired start time t₀, and achieve the objective action pose at the desired end time point td (also support an visible oscillator-style motion to decay the remaining motion energy after td within given time range [t_{d}, tₑ]), and the other is to keep the character's balance (not fall to and/or slide on the ground) for future interaction. Therefore, the optimization framework F is defined as follows:

Obj: Minimize/Maximize K

such that

$$\{ \begin{matrix}{C}_{U} < 0 \\ {C}_{{L}_{1}} ( t ) < 0 \\ {C}_{{L}_{2}} ( t ) < 0\end{matrix}$$

where t∈[t₀, t_{d}].

K is total kinetic energy of the whole body to achieve desired motion goal.

C_{U} is the constraint to check whether the PD-controller parameters of the current candidate motion strategy can be qualified to compose PD controller with a Under-damped-Harmonic-Oscillator solution for joint rotation position.

C_{L}_{₁} is the constraint to check whether the PD-controller parameters can achieve the objective action pose. Compared with the traditional optimization-based approach which employs full-dynamic forward simulation provided by the standard physics engine (such as ODE or Bul-let) to drive the motion directly to the time t_{d} and then check whether the motion has closely enough achieved the objective action pose, our method can quickly judge whether the candidate solution is workable while avoiding full-dynamic forward simulation which takes much more time for motion state computation of the whole body for each time step t. Only if for t∈[t₀, t_{d}] we have C_{L}_{₁}(t)<0, then the optimization framework will further check the current candidate using the next level constraint related to full-dynamic forward simulation such as to judge whether fall and/or slide in the given time range [t₀, t_{d}]).

C_{L}_{₂} is the constraint to check whether the PD-controller parameters of the current candidate motion strategy will make the character fall and/or slide on the ground.

### 2.1 Optimization Objective

Claim 6: The optimization framework in Claim 5, wherein optimization objective is provided to obtain minimized value or maximized value of the total kinetic energy of the whole body at desired time to achieve the desired motion pose.

The optimization objective Obj is defined as:

Minimize/Maximize: K=Σᵢ(−1)^{S}^{ᵢ}Kᵢ(t_{d})

Which minimizes or maximize the total kinetic energy K of the whole body at desired time point t_{d}. Sᵢ is used to determine the desired energy contribution of part i for a certain motion, and it equals to 0 when is required a maximum energy, 1 when minimum. Kᵢ(t_{d}) corresponding to kinetic energy of each body part i at time t_{d}, is computed as:

Kᵢ(t_{d})=½mᵢ\dot{T}ᵢ(t_{d})²,

Where mᵢ is the mass of Part i controlled by Joint i, and Tᵢ(t_{d}) is the linear velocity of Part i at t_{d}.

When the objective function is set to the minimization mode, the optimization tries to find an optimum solution to damp the kinetic energy and make the motion to stop at the desired pose at the desired time point td, which is usually used to find optimum solution to return to a statically balanced motion state as soon as possible such as standing balance.

When it is set to the maximization mode, the optimization tries to maximize the kinetic energy of the activated body parts at t_{d}, which is usually used to maximized the attack energy with the required fighting skill at t_{d}.

In our system, by default, t_{d} is set to the time point when the spine first reaches the desired angular position. This is based on the fact that the fighting motion or the balanced motion usually need the waist to coordinate the upper and lower body in order to regulate the total body energy to achieve the motion goal, namely either to obtain extra energy for the attack body parts, or to absorb the hitting energy from the opponent to keep balance after being attacked. Therefore, a natural and coordinated motion should be achieved by the style that when the waist achieve its own motion goal, all the other parts would also completely or nearly accomplish their own motion goals. If needed, t_{d} can be set to any other meaningful time point to coordinate the whole body motion.

Note that, if desired, the objective function can be also defined as maximization of the smoothness of the motion curves of key/all joints, or minimization of linear and/or angular motion of the key/all joints.

### 2.2 First Constraint: Under-Damped Harmonic Oscillator Constraint C_{U}

Claim 7: The optimization framework in Claim 5, wherein the first constraint of the total three is provided to validate whether the PD-controllers composing to a candidate motion strategy follows the law of Under-damped Harmonic Oscillator.

If a candidate motion strategy is potentially a workable one to achieve the motion goal, then the PD-controller parameters Kd and Kp should at least satisfy the conditions of Under-damped Harmonic Oscillator (about why Kd and Kp should satisfy this constraint, please refer to following proof), which requires that the damping rate ζ must satisfy:

$$1 - {ζ}^{2} = 1 - \frac{{Kd}^{2}}{4 * {I}_{i} * {Kp}_{i}} < 0$$

Due to its fast computation, it is set as the first constraint to eliminate the unworkable candidate motion strategy.

Proof:

Based on the analysis of the oscillator motion, we propose that under-damped harmony oscillator is enough to describe the angular motion curve generated human joint, namely to determine PD-controller parameters Kd and Kp.

Given the desired angular position Rᵢ(d), current motion state Rᵢ(t), \dot{R}ᵢ(t), the spring coefficient Kp and damping coefficient Kd, the joint torque is written as:

Tᵢ(t)=Iᵢ*\ddot{R}ᵢ(t)=−Kp*(Rᵢ(t)−Rᵢ_{_{d}})−Kd*(\dot{R}ᵢ(t))

The solution based on solving the above ordinary differential equation for any spring coef-ficieut Kp and damping coefficient Kd is:

$${R}_{i} ( t ) = \{ \begin{matrix}\begin{matrix}exp ( - {ζ}_{i} * t ) ( {c}_{1} exp ( t * \sqrt{{ζ}_{i}^{2} - 1} ) + \\ {c}_{2} exp ( - t * \sqrt{{ζ}_{i}^{2} - 1} ) ) + {R}_{i} ( d ) ,\end{matrix} & {ζ}_{i} > 1 \\ exp ( - {ζ}_{i} * t ) ( {c}_{1} + {c}_{2} t ) + {R}_{i} ( d ) , & {ζ}_{i} = 1 \\ {A}_{i} exp ( - {ζ}_{i} * t ) sin ( \sqrt{1 - {ζ}_{i}^{2}} {w}_{0} t + {φ}_{i} ) + {R}_{i} ( d ) , & {ζ}_{i} < 1\end{matrix}$$

Where

$${ζ}_{i} = \frac{{Kd}_{i}}{2 * \sqrt{{I}_{i} * {Kp}_{i}}} {w}_{0} = \sqrt{\frac{{Kp}_{i}}{{I}_{i}}}$$

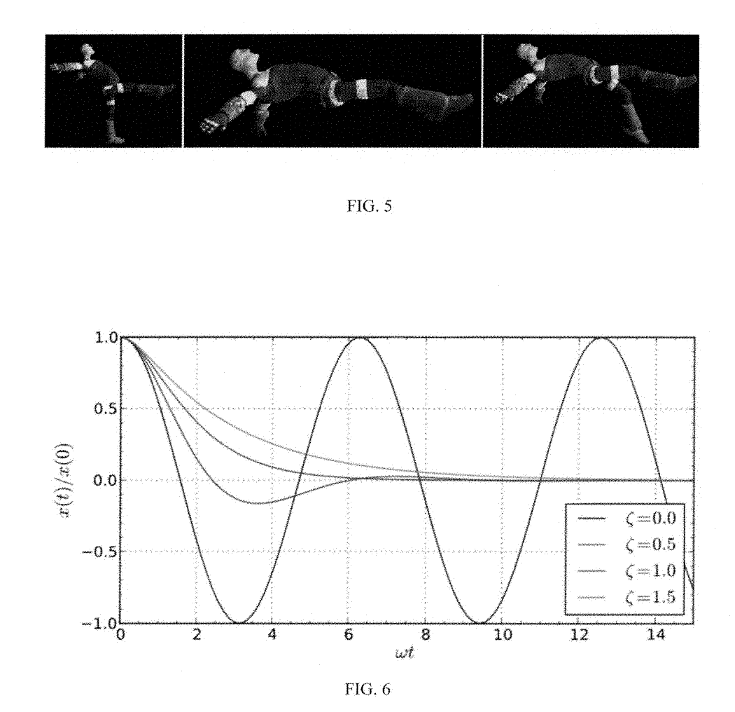

The oscillator with three solutions under these different conditions is respectively called over-damped, critical-damped and under-damped harmonic oscillator. The following FIG. 6 illustrates how the these different oscillator influence the motion of oscillator. FIG. 6 illustrates the type of oscillation is decided by the values of ζ It shows that:

when ζᵢ−1>0 such as ζᵢ=1.5, the oscillator (joint orientation in our system) returns to the steady state (desired angular position) without oscillating. The oscillator with larger values of the damping ratio ζᵢ would return to equilibrium slower.

when ζᵢ−1=0 namely ζᵢ=1, the oscillator returns to steady state as quickly as possible without oscillating. The oscillator with smaller values of the damping ratio ζᵢ would return to equilibrium slower.

when ζᵢ−1<0 such as ζᵢ=0.5 or 0.0, the system is oscillating around steady state, with the amplitude Aᵢ gradually decreasing to zero when ζᵢ>0.0, or with the amplitude Aᵢ no change when ζᵢ=0.0.

Based on the analysis of the oscillator motion under three different conditions, we propose that under-damped harmonic oscillator is enough to describe the angular motion curve generated human joint, and is demonstrate as follows:

In out research background, PD controller is employed to generate joint torque either for balanced motion or action with large energy such as the fighting.

When it is used for balanced motion, namely drive the body part return to the desired state with minimum energy, the under-damped oscillator with large damping ratio ζᵢ can quickly decay the motion energy and make the body part to return to the desired angular position even without perceivable oscillation (although there would be existing slight oscillation mathemati-cally).

When it is used for fighting motion, namely drive the body part return to the desired state with maximum energy, the joint driven by under-damped oscillator with small damping ratio ζᵢ can slowly decay the total oscillator energy (including kinetic and potential energy like a spring-mass system) while transferring potential energy to kinetic energy as much as possible before the first arrival to the desired state.

If needed, our system can extend to support an over-damped and/or critical harmonic oscillator. However, we should also consider whether it is worth it to greatly increase the optimization searching space especially to support the over-damped harmonic oscillator, which generates motions returning to desired angular position slowly.

### 2.3 Second Constraint: The First Lyapunov Function Constraint C_{L}_{₁}

Claim 8: The optimization framework in Claim 5, wherein the second constraint of the total three, based on the theory of Lyapunov Function, is provided to validate whether the candidate motion strategy can achieve the desired motion pose in time.

In order to judge whether the current selected control strategy Sᵢ can drive the character to achieve motion goal O within the time range [t₀,t_{d}], the traditional way in the optimization-based approach employs full-dynamic forward simulation to first drive the motion to the desired time t_{d}, and then judge whether the current motion state has reached or been near to the objective action pose.

However, this computation seriously influences the optimization performance due to checking candidate solutions in loop, each of which includes heavy full-dynamic physics computation for the forward simulation of whole body motion. Our proposed optimization framework is supposed to quickly find correct PD-Controller parameters to achieve the motion goal, as long as there exist at least one candidate motion strategy.

To our best knowledge, only the proposed optimization framework with Lyapunov function support can quickly check whether the candidate control parameters can achieve the motion goal. Lyapunov function is designed specially to analyze the dynamical stability in the dynamic system, such as the stability analysis of robot motion in the robotic area [BM10] and [ARnNB10]. [BM10] proposed a Lyapunov function based on linear velocity of the robot to smoothly switch between the motion controller to avoid obstacles and the controller to move to the target. [ARnNB10] proposed a Lyapunov function based both linear and angular velocity of the robot to analysis the stability of a motion controller to travel through a door from many different positions.

However, there is no standard technique to construct a Lyapunov Function which is used as a necessary and sufficient condition to quickly judge the motion stability (namely whether a controller can drive the motion to the desired pose), and therefore it is a challenge to find such a function, especially for human motion in the dynamics system which is a non-linear system. In order to avoid full-dynamic forwarded simulation during optimization as much as possible to speedup the optimization computation, a novel optimization constraint C_{L}_{₁} based on theory of Lyapunov's second method, is specially constructed as following equation shows, to efficiently predict: whether the motion, controlled by a candidate motion strategy with corresponding controllers' parameters searched in the optimization space, can achieve the objective action pose in the dynamic environment.

$${C}_{{L}_{1}} \text{:} \frac{d {L}_{1} ( t )}{dt} < 0 , where t ∈ [ {t}_{0} , {t}_{d} + {t}_{e} ]$$

### Where

t₀ is the required start time to make an new action controlled by the current candidate optimum solution. By default, it is the first start time for spine to move to the desired angular position.
t_{d}, is the desired end time to achieve that action. By default, it is the first end time for spine to get (near) to the desired angular position.
tₑ is an optional requirement, and is the extra time after t_{d} to confirm whether the candidate solution will generate a oscillator-style joint motion after the desired pose has been reached, such as setting this parameter as tₑ<=t_{d}−t₀ if the user want a obvious oscillator-style T-pose balanced standing, whose oscillating amplitude after t_{d} is decided by how large tₑ is
L₁(t) is the proposed Lyanunov Function based on the physics concept-potential energy at time t, and

$$\frac{d {L}_{1} ( t )}{dt}$$

is computed as follows:

$$\frac{d {L}_{1} ( t )}{dt} = \{ \begin{matrix}{\sum }_{i ∈ I} \frac{d {L}_{{1}_{i}} ( t )}{dt} , & if ∀ i ∈ I ⋂ ∀ t ∈ [ {t}_{0} , {t}_{d} + {t}_{e} ] , \frac{d {L}_{{1}_{i}} ( t )}{dt} \leq 0 \\ \frac{d {L}_{{1}_{i}}}{dt} , & if ∃ i ∈ I ⋂ ∃ t ∈ [ {t}_{0} , {t}_{d} + {t}_{e} ] , \frac{d {L}_{{1}_{i}} ( t )}{dt} > 0\end{matrix}$$

Where
I is the activated-joint set;
L₁_{ᵢ}(t) is the constructed Lyapunov Function for joint i at time t, and defined as follows:

L₁_{ᵢ}(t)=Wᵢ*Signᵢ(t)*U(Rᵢ(t),Rᵢ_{_{d}})
Where
Wᵢ is the weight (Wᵢ=1 by default) to emphasize how much Part i should be more important to achieve the objective action pose.
U(Rᵢ(t), Rᵢ_{_{d}}) is potential energy relative to desired pose R_{d}={Rᵢ_{_{d}}}, and is computed as:

U(Rᵢ(t),Rᵢ_{_{d}}))=½(Rᵢ(t)−Rᵢ_{_{d}})²
Where Rᵢ(t) is the angular position of part i at time t, and Rᵢ_{_{d}} is the desired angular position at desired time t_{d} to achieve. Based on the definition of U(Rᵢ(t),Rᵢ_{_{d}})), we analyze this item as following three conditions:
   1. When

$$\frac{dU ( {R}_{i} ( t ) , {R}_{{i}_{d}} )}{dt} < 0$$

Joint i will drive the corresponding body part to the objective orientation.
2. When

$$\frac{dU ( {R}_{i} ( t ) , {R}_{{i}_{d}} )}{dt} = 0 ,$$

Joint i will generate no rotation.
3. When

$$\frac{dU ( {R}_{i} ( t ) , {R}_{{i}_{d}} )}{dt} > 0 ,$$

the torque generated by Joint i will drive the body part moving away from the objective orientation.
Signᵢ(t) is defined as follows:

$${Sign}_{i} ( t ) = \{ \begin{matrix}1 , & \begin{matrix}if {R}_{i} ( t ) ∈ {Pha}_{i} ( t ) ⋂ \\ t ∈ [ t ( 0 ) , t ( d ) ]\end{matrix} \\ - 1 , & \begin{matrix}if {R}_{i} ( t ) ∈ {Pha}_{i} ( t ) ⋂ \\ t ∈ [ t ( d ) , t ( e ) ]\end{matrix} \\ n , such that \text{:} ( \vert n \vert = 1 ) ⋂ ( \frac{d {L}_{{1}_{i}} ( t ) )}{dt} > 0 ) , & if {R}_{i} ( t ) ∉ {Pha}_{i} ( t )\end{matrix}$$

It is used to check whether the angular position Rᵢ(t) of Part i is in the right phase Phaᵢ(t) relative to the spine's phase at time t, namely whether Rᵢ(t)∈Phaᵢ(t) or not.
Before further discussion on Signᵢ(t), in order to define Rᵢ(t) E Phaᵢ(t), some important notations is defined and explained as follows:
   Phase ID: based on the angular position of initial oscillator phase φ, assuming φ∈[0, 2π], then the phase space for each activated joint is divided into four equal sub-spaces, namely Phase 1 [0, π/2), Phase 2 [π/2, π), Phase 3 [π, 3π/2), and Phase 4 [3π/2, 2π). Therefore, Phase ID is defined as the number of the sub-space which the oscillator phase is in as following equation defines.

$$PhaseID ( t ) = \{ \begin{matrix}1 , & if φ ∈ [ 0 , π \text{/} 2 ) \\ 2 , & if φ ∈ [ π \text{/} 2 , π ) \\ 3 , & if φ ∈ [ π , 3 π \text{/} 2 ) \\ 4 , & if φ ∈ [ 3 π \text{/} 2 , 2 π )\end{matrix} \}$$

Oscillator Phase for t_{d}: based on the fact that the angular position for the body part driven by the corresponding activated joint is desired to get to the required value Rᵢ(t_{d}) at the desired time t_{d}, and the required value Rᵢ(t_{d}) corresponds to the equilibrium point in the oscillator formulation (namely the point when oscillator phase is π or 2π), therefore t_{d} happens either at Oscillator phase π or 2π.
Oscillator Phase for t₀: based on the definition of t₀, t₀ is the first starting time point for the body part to move to the desired angular position, that we infer that t₀∈Phase 2 or 4 to achieve the objective pose happened at equilibrium point. Namely at time t_{d}, its oscillator phase equals to either π when t₀∈Phase 2, or 2π when t₀∈Phase 4.
Phaᵢ(t): is defined as the desired Phase ID for Joint i at time t, namely as following equations shows. We know that in our system by default t₀ and t_{d} is decided by spine's motion, so the oscillation phases to be referred for all the activated joints except spine at time t₀ and t_{d} is directly computed using spine's oscillation phases. Further, for any Joint i, if Phaᵢ(t) will have the same phase ID as Phaₛₚᵢₙₑ(t) if and only if this joint is moving to the equilibrium point with the exact same way (same sign of angular positions and velocities) of spine, Phaᵢ(t) will have the opposite phase ID (namely Phaᵢ(t)%2==(Phaₛₚᵢₙₑ(t)+2)%2) if and only if this joint is moving to the equilibrium point with the opposite way (opposite sign of angular positions, and velocities) of spine.
Based on the above four definition, Rᵢ(t) E Phaᵢ(t) is defined as the following equation:

$${R}_{i} ( t ) ∈ {Pha}_{i} ( t ) = \{ \begin{matrix}t ∈ [ {t}_{0} , {t}_{d} ] ⇒ {Sign}_{i} ( t ) = 1 \\ t ∈ [ {t}_{d} , {t}_{e} ] ⇒ {Sign}_{i} ( t ) = - 1\end{matrix} \}$$

Namely, the current oscillator phase of Joint i has the phase ID equal to Phaᵢ(t), which further means Joint i is in the desired phase field to move to the desired phase objective which corresponds to the objective angular position for Joint i. Further, note that:
When t∈[t₀, t_{d}], Rᵢ(t)∈Phaᵢ(t) indicates that Rᵢ(t) is either in Phase 2 or 4;
When t∈[t_{d}, tₑ], Rᵢ(t)∈Phaᵢ(t) indicates that Rᵢ(t) is either in Phase 1 or 3; then we have the following important conclusion which would be used to prove the correctness of our Lyapunov Constraint:

$$\begin{matrix}t ∈ [ {t}_{0} , {t}_{d} ] \\ {R}_{i} ( t ) ∈ {Pha}_{i} ( t )\end{matrix} \} ⇒ R ( t ) * \dot{R} ( t ) \leq 0 \\ \begin{matrix}t ∈ [ {t}_{d} , {t}_{e} ] \\ {R}_{i} ( t ) ∈ {Pha}_{i} ( t )\end{matrix} \} ⇒ R ( t ) * \dot{R} ( t ) \geq 0$$

Then, we will discuss how Rᵢ(t)∈Phaᵢ(t) decides Signᵢ(t)'s value, and then influence the progress of the optimization framework.
A. If yes, namely Rᵢ(t)∈Phaᵢ(t), the system will then check whether t∈[t(0), t(d)] or t∈[t(d), t(e)].
   (a) If t∈[t(0), t(d)], based on the definition of Signᵢ(t), Signᵢ(t)=1. Then the system directly jump to computation of pure Lyapunov-function-theory based equation

$$( namely \frac{d {L}_{{1}_{i}} ( t ) )}{dt} = \frac{{dW}_{i} * U ( {R}_{i} ( t ) , {R}_{{i}_{d}} )}{dt} )$$

to judge whether the candidate solution will drive the activated joints to achieve objective pose.
(1) If

$$\frac{d {L}_{{1}_{i}} ( t ) )}{dt} < 0 ,$$

then the current solution works on Lyapunov-based constraint.
(2) Else, the optimization framework will not only quit the further test for the left activated joint, but also for the left constraints using the current candidate solution, which is the key feature to quickly eliminate the unworkable candidate solutions and avoid the next levels of constraint computation especially related to the full-dynamic forward simulation.
(b) If t∈[t(d), t(e)], rather than to check whether the current motion can achieve the objective pose, the system will check whether the current solution can generate an oscillator-style action

$$( if \frac{d {L}_{{1}_{i}} ( t ) )}{dt} < 0 ,$$

then the current solution can generate an oscillator-style action, whose oscillation amplitude is decided by how large t(e) is), such as for a oscillator-style T-pose balanced standing.
B. If no, namely Rᵢ(t)∉Phaᵢ(t), Signᵢ(t) will have a value which makes

$$\frac{d {L}_{{1}_{i}} ( t ) )}{dt} > 0 ,$$

namely the system can stop further computation of this constraint for the left parts and judge the current candidate solution failed on this constraint.
Based on the definition of U(Rᵢ(t), Rᵢ_{_{d}})),

$$\frac{d {L}_{{1}_{i}} ( t )}{dt}$$

is computed as:

$$\frac{d {L}_{{1}_{i}} ( t )}{dt} = {W}_{i} * {Sign}_{i} ( t ) * {I}_{i} ( {R}_{i} ( t ) - {R}_{{i}_{d}} ) * {\dot{R}}_{i} ( t ) ,$$

where t∈[t₀, t_{d}]
Where \dot{R}ᵢ(t) is the angular velocity of part i. Based on the equation introduced (in Section An novel approach to regulate PD-Controller) to compute angular position Rᵢ(t) driven by a under-damped harmonic oscillator at time t, \dot{R}ᵢ(t) is computed as:

\dot{R}ᵢ(t)=2Aᵢπ*cos(φᵢ+2π*t/Tᵢ)*exp(−t/dtᵢ)/Tᵢ−Aᵢ sin(φᵢ+2π*t/Tᵢ)*exp(−t/dtᵢ)/dtᵢ
Further

$$\frac{d {L}_{1} ( t )}{dt}$$

is re-written to:

$$\frac{d {L}_{1} ( t )}{dt} = \{ \begin{matrix}\begin{matrix}{\sum }_{i ∈ J} {W}_{i} * {Sign}_{i} ( t ) * \\ {I}_{i} ( {R}_{i} ( t ) - {R}_{{i}_{d}} ) * {\dot{R}}_{i} ( t ) ,\end{matrix} & if ∀ i ∈ J ⋂ ∀ t ∈ [ {t}_{0} , {t}_{d} + {t}_{e} ] , \frac{d {L}_{{1}_{i}} ( t )}{dt} \leq 0 \\ \frac{d {L}_{j} ( t )}{dt} , & if ∃ j ∈ J ⋂ ∃ t ∈ [ {t}_{0} , {t}_{d} + {t}_{e} ] , \frac{d {L}_{{1}_{i}} ( t )}{dt} > 0\end{matrix}$$

### Conclusion:

The current candidate optimum solution can satisfy the Lyapunov-Function-based constraint if and only if the following two conditions satisfy:

For all of the activated joints:

A. When t∈[t₀, t_{d}], Signᵢ(t)=1, and

$$\frac{dU ( {R}_{i} ( t ) , {R}_{{i}_{d}} ) )}{dt} < 0 ,$$

then we have

$$\frac{d {L}_{1} ( t )}{dt} < 0$$

within [t₀, t_{d}], which namely means the activated joints will drive the corresponding angle to the objective pose. This is conclusion basically supported by Lyapunov-Function theory, which will be proved in the Appendix “Proof: Correctness of Lyapunov Function Constraint”.

B. When t∈[t_{d}, tₑ] (if tₑ>t_{d}, namely the activated joints are required to generate an oscillator-style action), Signᵢ(t)=−1, and

$$\frac{dU ( {R}_{i} ( t ) , {R}_{{i}_{d}} ) )}{dt} > 0 ,$$

then we have

$$\frac{d {L}_{1} ( t )}{dt} < 0$$

within [t_{d}, tₑ], which namely means the activated joints will generate an oscillator-style action, whose oscillation amplitude is decided by how large tₑ is), such as for a oscillator-style T-pose balanced standing. By this constraint, the optimization framework can quickly eliminate unworkable candidate solution (either not to achieve the objective pose, or generate a required oscillator-style action within the required time range [t_{d}, tₑ] after passing the objective pose at time t_{d}), and avoid further time-consuming constraint evaluation especially the heavy computation related to the full-dynamic forward simulation.
Influence from Other Forces

Note that, in this constraint, Rᵢ(t) is expected to be computed as fast as possible to filer the candidate solutions to achieve the objective pose by a kinematic way using oscillation equation, rather then forward simulation which also considers other forces such as gravity and ground reaction. This simplification is based on the fact that in the fighting motions, the muscle will generate much larger force to drive body part motion compared with the motion influence from gravity of that part, and that's why the influence from part gravity to the joint motion at this condition can be ignored.

### 2.4 Third Constraint: The Second Lyapunov Function Constraint C_{L}_{₂}

Claim 9: The optimization framework in Claim 5, wherein the third constraint of the total three, based on the theory of Lyapunov Function, is provided to validate whether a candidate motion strategy can ensure a balance motion after achievement of desired pose.

In order to judge whether the current candidate solution Sᵢ can keep a balanced motion to achieve the objective pose, the second Lyapunov Function Constraint C_{L}_{₂}, defined as follows, is proposed to predict whether the current candidate solution can generate a balanced motion. Based on the data sampled from background forward simulation within time range [tₛ_{₀},tₛ_{₁}], the candidate motion can not only filter the workable candidate solution to generate balanced motion within [tₛ_{₀}, tₛ_{₁}], and but also can predict the future simulated motion's balance state after tₛ_{₁} based on the Lyapunov stability theory.

C_{L}_{₂}: \dot{L}₂(x)<0, where t∈[tₛ_{₀},+∞]

### Where

tₛ_{₀}, is the desired start time to sample data.
L₂(t) is the proposed second Lyapunov Function based on the total energy of the COM point along the Axis X and Z. The difficulty is that not only there is no standard way to create the Lyapunov Function for a special application, but also there is no reference to construct Lyapunov Function to analyze the motion balance problem, so the proposed second Lyapunov Function is the key potential contribution of this paper. The following sub-sections will define the proposed second Lyapunov Function and to show how it works.

### Overview of Contribution of C_{L}_{₂}

Our optimization framework with C_{L}_{₂} will overcome all of the previous mentioned drawbacks. The most important contribution of this constraint is that: given any candidate solution for no matter balance locomotion or standing with or without fighting action, our system will has the following two important abilities: 1) To judge whether the current controller keep balance during moving to the objective pose. 2) If not, to judge whether an candidate solution provided by the optimization work can generate a balanced motion within the sample time range which covers the time point to achieve the objective pose, and then to predict whether it can generate a balance motion after achieving the required objective pose, which is not done by all of there previous solutions as far as we've known.

Because the available suite of mathematical tools for the stability analysis of high-dimensional, non-linear dynamical systems is limited, therefore it is hard to directly derive the equation for explicit stability analysis. Two practical options for analysis are to work with a simplified version of the system dynamics, or to rely on heuristic ways based on simulation-based experiments such as [YLvdP07] [dSAP08], which is also chosen by us.

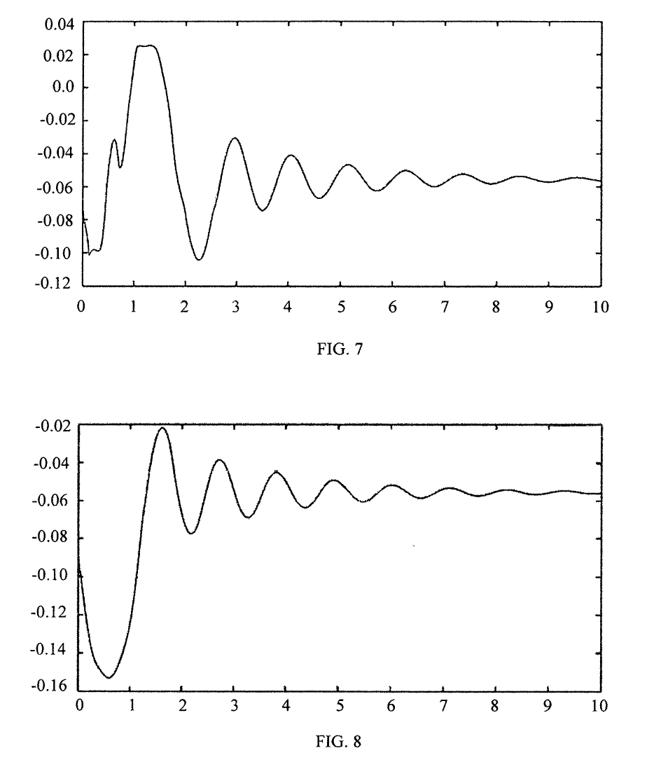

After evaluating of the full-dynamic balance motion curve of the COM as shown in FIGS. 7, 8, 9, 10 and 11 which cover balanced standing with/without being attacked, walking with/without being attacked, and jumping, we've found that as long as the motion controller can achieve the motion goal (to achieve the objective action pose(s) while keep balanced), the COM point will generate an under-damped-harmonic-oscillation style of motion around the desired position in the local coordinate system of the foot support area. As far as we've known, we are the first ones to discover this interesting phenomenon, which is also partly supported by the other solutions which assume that the near the COM point gets to the center of foot support area, the more balanced state the current motion controller will be.

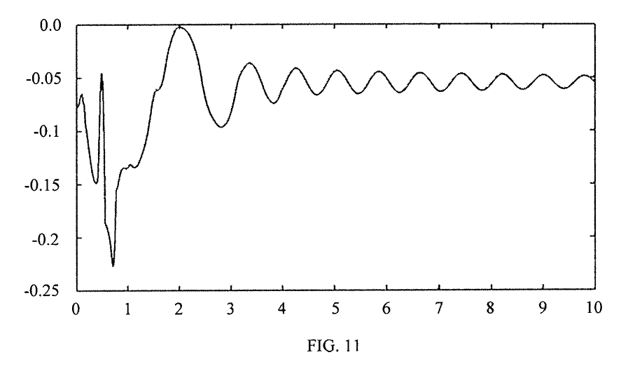

FIG. 7 illustrates a motion curve of COM point driven by a simple standing balance controller with three activated joints on two shoulders and torso without disturbance. Its initial and desired pose is the same as FIG. 11 shows

FIG. 8 illustrates a motion curve of COM point driven by a simple standing balance controller with three activated joints on two shoulders and torso with disturbance. Its initial and desired pose is as the right picture of FIG. 12 shows

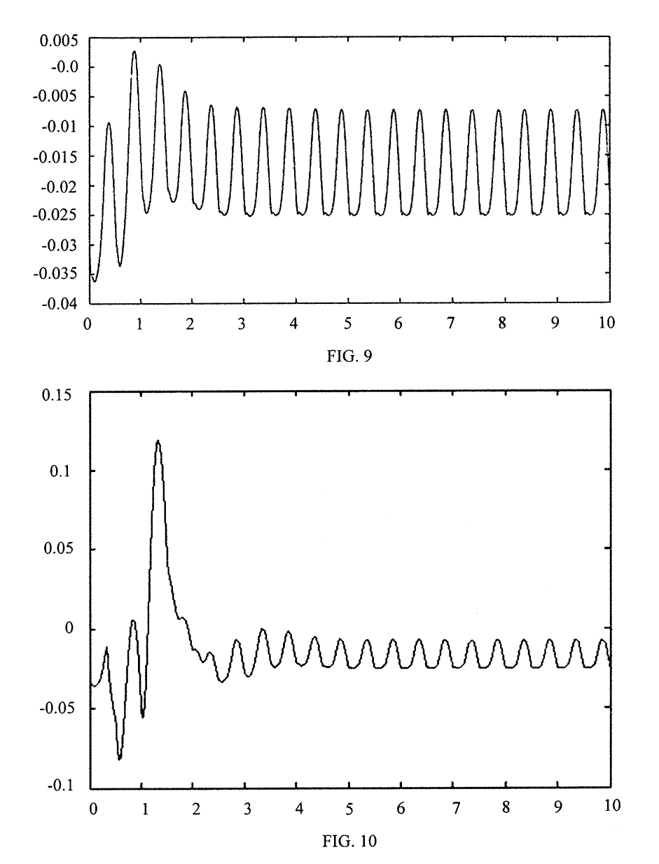

FIG. 9 illustrates a motion curve of COM point driven by a walking balance controller without being attacked.

FIG. 10 illustrates a motion curve of COM point driven by a walking balance controller under attack.

FIG. 11 illustrates Motion curve of COM point driven by a simple jumping balance controller with three activated joints on two shoulders and torso.

Based on this phenomenon, we propose an assumption that: as long as a controller can generate a balance motion, then the motion curve of COM's projection on the ground should have an oscillation-style motion around the desired COM position in the local coordinate system of the foot support area.

Then, based on this assumption, a virtual non-linear PD-controller is proposed to simulate the COM point's oscillation-style motion in the projection plane during a balance motion. The physics explanation is that, this virtual non-linear PD-controller simulates the influence from the torques of body gravity to the CP point and the torques generated by the all of the individual joint torques.

Then, based on the theory of Lyapunov's second method, an energy-based Lyapunov Function, including the kinetic energy and potential energy generated by the proposed virtual PD-controller, is proposed as a constraint of our optimization system to judge whether the current control solution can generate an balance motion by:

Firstly, this constraint implies that, based on theory of Lyapunov's second method, a successful balance controller will lead to the COM point's motion to be locally positive stable, which means by following the virtual PD-controller's motion, the COM's motion will follow an oscillation.

Secondly, based on Lasalle's principle and fact that the total energy of the whole body decays continuously due to the fact that in our system join motion controlled by PD-controller which has an damping coefficient K_{d}, this constraint further gets a stronger implication that COM point's motion is locally asymptotically stable, which means COM point will return to an equilibrium point with the oscillation amplitude asymptotically decreasing. We get a much stronger conclusion than the assumption: if a motion is stable, then the COM point follows an under-damped harmonic oscillation style of motion.

Third, based on the above stability conclusion of the COM point, a further set of related sub-constraint is proposed for the balance prediction of the COM point. Namely a motion is balanced only if it satisfies two sets of significant sub-constraints: 1) sub-constraints making sure that the motion of the COM has at least one period of under-damped harmonic oscillation. 2) sub-constraints making sure that the motion influenced by the amplitude of the first under-damped harmonic oscillation is within the foot support area (FSA).

### Virtual PD-Controller Model for the Motion of the COM Point

Based on the proposed assumption, just as the motion style shown in FIG. 12, a candidate balanced solution is supposed to drive the COM point to move to the desired COM position x* with an oscillation style. Because a PD-controller can simulate this feature, a model of virtual PD-controller to approximate the COM motion around x* is proposed as follows:

m_{c}\ddot{x}ᵢ=−Kpᵢ(xᵢ)*(xᵢ−xᵢ*)−Kd(\dot{x}ᵢ)*\dot{x}ᵢ
Kd(\dot{x}ᵢ) is the damping coefficient, which is directly non-linearly influenced by the velocity of the COM point.
Kp(xᵢ) is further defined as the spring coefficient which is non-linearly influenced by the translation of the COM point.

### Design of L₂(t)

Based on the design of virtual PD-controller, L₂(x) is defined as the total energy of the COM point along Axis X and Z, and computed as follows:

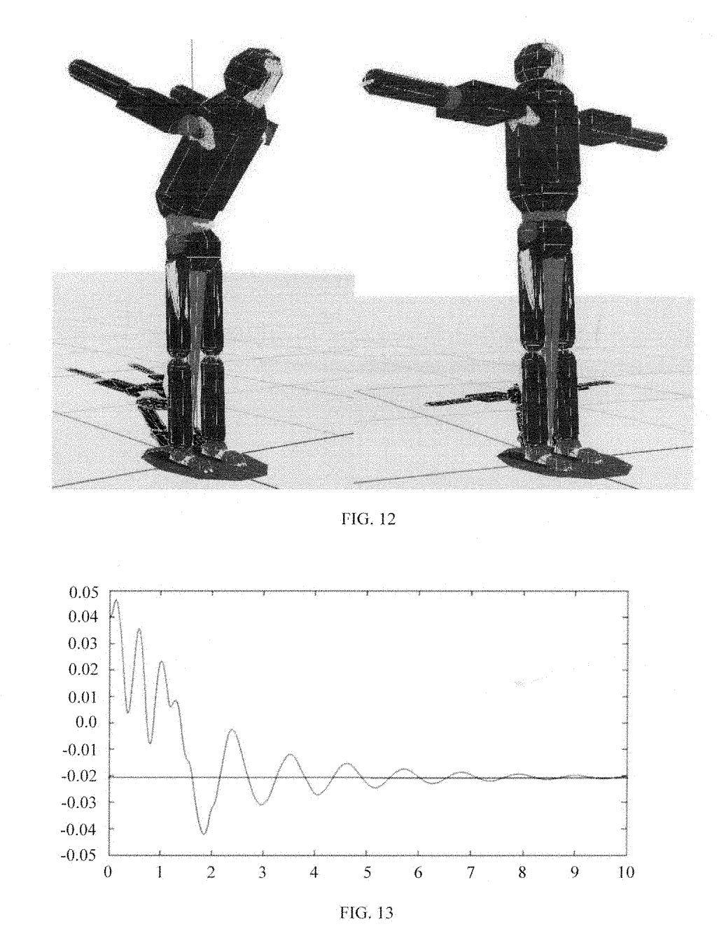

L₂(x)=maxᵢ₌₁²L₂(xᵢ)

Where L₂(xᵢ) is energy component along Axis X when i=1 or Axis Z when i=2, and is computed as: L₂(xᵢ)=½m_{c}\dot{x}ᵢ²∫ₓ_{ᵢ}_{*}^{x}^{ᵢ}Kpᵢ(uᵢ)(uᵢ−xᵢ*)duᵢ
m_{c}, is the mass of whole body.
x, is the position of the COM (center of mass) in the world coordinate system.
x₁ and x₂ is respectively the component along Axis X and Z of the coordinate of the COM (center of mass) in the world coordinate system.
\dot{x}₁ and \dot{x}₂ is the absolute velocity of the COM in the world coordinate system.
Kp₁ and Kp₂ is respectively the non-linear coefficient of virtual spring force along Axis X and Z. This virtual spring force is proposed based on the observation of the balanced motion, such as the example to show the standing balance in FIG. 12 and its motion curve of COM point along Axis Z as shown in FIG. 11. Therefore, similar with the influence from joint torques to drag the body part to move to the desired angular position, a virtual spring force is designed to drag the COM point to the desired position x*, which is the COM position when the objective pose is achieved. This virtual spring force physically simulates the influence from the combination of the gravity torque which makes body to fall, and joint torque which drag the body parts back to their desired angular position.
Note that x* must be within the foot support area so that the optimization framework will employ this constraint to find a solution to generate balanced motion, or else the optimization framework will ignore this constraint because no balanced solution exists.
FIG. 12 illustrates a standing balance: the left picture shows its initial pose, and the right picture shows its finally position after the joint controllers decay the motion energy. The circle on the ground is the foot support area.
FIG. 13 illustrates a motion curve to show the trajectory of the COM point along Axis X during balanced stranding. The COM point finally stops at the desired position whose translation component along the Axis Z stops at around −0.02 m, the desired position is at 0.0 m.
½m_{c}xᵢ² where i=1 or 2, is therefore the kinetic energy based on the above definition.
∫ₓ_{ᵢ}_{*}^{x}^{ᵢ}Kpᵢ(uᵢ)(uᵢ−uᵢ*)duᵢ where i=1 or 2, is therefore the spring potential energy. Obviously, if the toque for all the joints is large enough to overcome the its corresponding gravity torque, then the candidate optimum solution should drive the COM point to stop at or at least visually very near to the desired point x*. Just FIG. 11 shows, the translation component along the Axis X of the COM's desired position is at −0.0 m, and the simulated final translation is −0.02 m.

Based on the definition L₂(x), we have

\dot{L}₂(x)=maxᵢ₌₁²(m_{c}\dot{x}ᵢ\ddot{x}ᵢ+Kpᵢ(xᵢ)*(xᵢ−xᵢ*)*\dot{x}ᵢ)

### Constraint Evaluation Based on Virtual PD-Controller Model

Based on m_{c}\ddot{x}ᵢ=−Kpᵢ(xᵢ)*(xᵢ−xᵢ*)−Kd(\dot{x}ᵢ)*\dot{x}ᵢ defined for our virtual PD-Controller model, \dot{L}₂(x) can be further re-written to:

\dot{L}₂(x)=maxᵢ₌₁²\dot{L}₂(xᵢ)=maxᵢ₌₁²−\dot{x}ᵢKd(\dot{x}ᵢ)\dot{x}ᵢ=−maxᵢ₌₁²Kd(\dot{x}ᵢ)\dot{x}ᵢ²

It can be seen that the sign of \dot{L}₂(xᵢ) is decided by \dot{L}₂(xᵢ), which further decided by Kd(\dot{x}ᵢ).

Based on Lyapunov's second method, as long as \dot{L}₂(xᵢ)<0 such that \dot{x}ᵢ∈[\dot{x}ᵢ_{ₘᵢₙ},\dot{x}ᵢ_{ₘₐₓ}] where \dot{x}ᵢ_{ₘᵢₙ} and \dot{x}ᵢ_{ₘₐₓ} is constant, then we can confirm the desired equilibrium point xᵢ* is locally positive stable. If for each i=1, and 2, we have xᵢ* is locally positive stable, and then we will have \dot{L}₂(xᵢ)≦0, and finally we have \dot{L}₂(x)≦0.

Further, based on Lasalle's principle, the conclusion that xᵢ* is locally positive stable for an non-linear controller will lead xᵢ* to be locally asymptotically stable due to Kd(\dot{x}ᵢ) to decay the motion energy continuously (the proof is similar to the one in the book [ML94]), which means COM point will return to xᵢ* with oscillation amplitude asymptotically decreasing.

Note that “xᵢ* is asymptotically stable” is usually the ideal final state of a motion to keep achieved motion balanced, such as the balanced standing shown in FIG. 12, in which the nearer the COM point is to x* finally, the better the candidate solution achieves a balanced standing with the desired pose.

In summary, Kd(\dot{x}ᵢ) is the key component to directly influence the locally asymptotically stability of x* under the control of the current candidate solution.

Our strategy is to judge Kd(\dot{x}ᵢ)≧0, which leads to \dot{L}₂(xᵢ)=−Kd(i)\dot{x}ᵢ²≦0 for each component, and then we can get \dot{L}₂(x)=maxᵢ₌₁²\dot{L}₂(xᵢ)≦0.

The following introduces 2 method to obtain Kd(\dot{x}) while \dot{x}ᵢ∈[−\dot{x}ᵢ_{ₘₐₓ},\dot{x}ᵢ_{ₘₐₓ}].
1. One candidate solution to obtain Kd(\dot{x}ᵢ) is to explicitly to derive an equation for Kd(\dot{x}ᵢ). However, due to complex computation embedded in the physics engine with combination of the torque of different activated joints required by animator, this equation seems quite hard to obtain. That's why we prefer the next method.
2. The basic idea to obtain Kd(\dot{x}ᵢ) is to sample the COM point's position x within time [tₛ_{₀},tₛ_{₁}] by either of the following two approaches:
   a) Full-dynamic forward simulation (slower but more accurate) provided by physics engine (which is a standard way to evaluate a candidate solution in a full-dynamic system in the optimization framework.
   b) Forward kinematic evaluation, which is more quickly but less accurate due to factors such as, ignoring gravity by assuming the gravity of a body part can be ignore when joint motion driven by the corresponding joint has large torque, and other settings embedded in the physics engine which influence the motion.
   Our choice is to use full-dynamic forward simulation to potentially make a more precise perdition of the balance state.
   Note that as similarly discussed in Section 4 about why to simulate human joint motion as under-damped harmonic oscillation, we still use this description to compute the K_{d} of the COM point, which also coincides well with our observation on the balanced motion of the COM point simulated on our platform.
   Similar with the under-damped harmonic oscillation equation mentioned in Section 4 to compute joint angular position as follows:

Rᵢ(t)=Aᵢ* exp(−t/dtᵢ)*sin(2π*t/Tᵢ+φᵢ)+Rᵢ(d)
The under-damped harmonic oscillation equation to compute mass translation around desired position x_{d} is defined as follows:

xᵢ(t)=Aᵢ* exp(−t/dtᵢ)*sin(2π*t/Tᵢ+φᵢ)+xᵢ(d)
Then based on the above equation and obtained xᵢ within time [tₛ_{₀},tₛ_{₁}], we can first solve A, dt, T, fi, x_{d} and then get Kd(\dot{x}ᵢ) by the following equation:

$$\{ \begin{matrix}Kd = \frac{2 m}{dt} \\ Kp = \frac{m}{{dt}^{2}} + \frac{4 m {π}^{2}}{{T}^{2}}\end{matrix} \}$$

During computation of Kd(\dot{x}ᵢ) for the sample time points within [tₛ_{₀},tₛ_{₁}], some sub-constraints must be satisfied as follows, else the optimization work will quit further computation of this constraint and judge the current candidate solution as false:

$$\{ \begin{matrix}{C}_{KP} \text{:} Kp \geq 0 \\ {C}_{KD} \text{:} Kd \geq 0 \\ {C}_{U} \text{:} 1 - \frac{{Kd}^{2}}{4 * {m}_{C} * Kp} \geq 0 \\ {C}_{A} \text{:} COM ∈ FAS when 1 st Oscillation \\ happens around desired COM position \\ {C}_{COM} \text{:} COM ∈ FAS\end{matrix} \}$$

C_{KP} makes sure that the Kpᵢ suffice the definition of spring coefficient.
C_{KD} makes sure that the Kdᵢ suffice the definition of damping coefficient. Based on the equation Kd=2*m/dt to compute Kdᵢ, it is further decided by the sign of dt, which namely decide whether the oscillation will decrease its amplitude continuously, or increase like adding external forces the oscillator. Obviously, the former condition needs to make the motion energy of COM decay.
C_{U} makes sure that the Kp(xᵢ) and Kd(\dot{x}ᵢ) at each sample point satisfies the condition requirement of an Under-damped Harmonic Oscillator. Based on the observation of the balance motion we simulated, we've found that the motion curve of the COM point which can pass xᵢ* and finally stop at or around the objective pose always moves with an Under-damped Harmonic Oscillator style, which means the COM point would always at least have a little oscillation to finally stop at xᵢ*.
C_{A} makes sure that after a hit(if available) to the character, whether the first oscillation around the desired COM position is within FSA. If so, then the current motion is balanced; if not, the constraint will stop optimization framework for further sampling operation and Judge balance state as false. By default, whether the 1st oscillation is within FSA is enough to fast judge a balanced motion, because the PD-controllers of all the body parts will decay the extra motion energy due to hit and the first oscillation around the desired COM will has its largest amplitude.
C_{COM} makes sure that the current sampled motion state is balance, if not that the constraint will stop further sampling operation. This sub-constraint provides a very fast but effective judgment of the current motion state. This is also the tradition way to guess the future motion state outside the sampling window. However, because this method can not predict correctly the future state, especially in the situation that the sampling time window is not wide enough to cover the time which the motion reaches its un-balanced condition. This situation is the most important reason for our system to propose the second Lyapunov-function based constraint to much more accurately predict the un-balanced state of the future motion. In sum, this sub-constraint is only used to judge current state in this Lyapunov constraint, and other sub-constraints based on the Lyapunov-function and related computation are in charge of future prediction.
After confirmation of Kd(\dot{x}ᵢ)≧0 within [tₛ_{₀}, tₛ_{₁}], then we can confirm the equilibrium point x* is locally asymptotically stable. Assuming [\dot{x}ᵢ_{ₘᵢₙ}, \dot{x}ᵢ_{ₘₐₓ}] is the oscillation velocity boundary also obtained from forward simulation within [tₛ_{₀},tₛ_{₁}], we conclude that this range will also be the largest velocity within [tₛ_{₁},+∞] because x* is locally asymptotically stable, namely \dot{x}ᵢ∈[\dot{x}ᵢ_{ₘᵢₙ},\dot{x}ᵢ_{ₘₐₓ}] within [tₛ_{₀}+∞]. Then we have −maxᵢ₌₁²Kd(\dot{x}ᵢ)\dot{x}ᵢ²≦0 where \dot{x}ᵢ∈[\dot{x}ᵢ_{ₘᵢₙ},\dot{x}ᵢ_{ₘₐₓ}] within [tₛ_{₀}+∞], namely \dot{L}₂(x)≦0 within [tₛ_{₀},+∞].
Therefore, as long as all the above sub-constraints are satisfied, we will have the following important conclusion:
1. \dot{L}₂(x)≦0 within [tₛ_{₀},+∞].
2. The equilibrium point x* is locally asymptotically stable, which means the candidate solution will not only achieve the objective pose, but also finally stop at or visually very near to the position of the COM point of the desired pose. Note that if the spring coefficient of the activated joint is sufficient large, then the COM point will visually stop at the desired equilibrium point x* finally.

### 2.5 Other Constraints

Bio-Mechanic Constraint C_{B}

Bio-Mechanic Constraint C_{B} is used to limit the joint rotation within a meaningful range which a normal human being can achieve, and this constraint is achieved in the forward simulation. Namely, when a rotation boundary is reached, the physical engine will stop further rotation.

PD-Controller Constraint C_{P}

PD-Controller Constraint C_{P} is used to generally set the range for Kd and Kp, which are the only two factors to be adjusted to influence the future joint rotation. An experienced animator can potentially set a more meaningful range for these parameters, which can greatly decrease the optimization searching space and therefore speed up optimization. However it is still very tricky and time consuming to adjust parameters for a new style of motion, which is also why an automatic way such as optimization-based approach is widely used to find adaptive values to achieve a new motion goal.

### BIBLIOGRAPHY

[ARnNB10] AKANYETI O., RA\ddot{N}Ó I. N., NEHMZOW U., BILLINGS S. A.: An application of lyapunov stability analysis to improve the performance of narmax models. Robot. Auton. Syst. 58, 3 (March 2010), 229-238.
[BM10] BENZERROUK A. A. L., MARTINET P.: Lyapunov global stability for a reactive mobile robot navigation in presence of obstacles. In In ICRA '10 International Workshop on Robotics and Intelligent Transportation System. (2010).
[dSAP08] DA SILVA M., ABE Y., POPOVIĆ J.: Interactive simulation of stylized human locomotion. In ACM SIGGRAPH 2008 papers (New York, N.Y., USA, 2008), SIGGRAPH '08, ACM, pp. 82:1-82:10.
[ML94] MURRAY R. M., LI Z.: A Mathematical Introduction to Robotic Manipulation. CRC Press, Boca Raton, Fla., USA, 1994.
[YLvdP07] YIN K., LOKEN K., VAN DE PANNE M.: Simbicon: simple biped locomotion control. ACM Trans. Graph. 26, 3 (July 2007).

1: A simulation system is provided to generate diverse responsive motions in a full-dynamic environment while not being constrained by the scale of the motion capture database or even with no motion data supports. When an avatar in the system is hit by another, the system halts and asks animator to create a motion goal including a desired time to achieve the goal, a desired pose, and a desired motion strategy which is selected from a provided motion database. After the motion goal is set, an optimization framework is provided to find optimal solution to achieve such a goal while keeping avatar's motion balance after achievement of the motion goal.

2: The simulation system in claim 1, wherein the motion database includes both a PD-controller database providing the basic joint PD controllers to drive the rotations of body parts, and a motion strategy database, each element of which is a motion strategy composed of several simple PD-controllers from PD controller database to achieve a certain human motion such as a punch, locomotion, a jump or balanced standing.

3: The motion database in claim 2, wherein the PD-controller database include 14 elements for totally 14 joints (namely torso, lHip, rHip, head, lShoulder, rShoulder, lKnee, rKnee, lElbow, rElbow, lAnkle, rAnkle, lToe, and rToe), and each element of this database is a joint PD controllers to drive the rotation of corresponding body part.

4: The motion database in claim 2, wherein the strategy database provides 4 basic types of motion strategies (namely standing, locomotion, jumping and punching), and each strategy is composed of several key poses for that motion type, and each key pose is composed of a combination of joint orientations for all 14 joints defined in the provided PD-controller Database claimed in claim 3.

5: The simulation system in claim 1, wherein the optimization framework, given an initial motion state and the motion goal set by animator, is provided to find the optimal motion strategy to minimize or maximize motion energy cost as its optimization objective under three constraints.

6: The optimization framework in claim 5, wherein optimization objective is provided to obtain minimized value or maximized value of the total kinetic energy of the whole body at desired time to achieve the desired motion pose.

7: The optimization framework in claim 5, wherein the first constraint of the total three is provided to validate whether the PD-controllers composing to a candidate motion strategy follows the law of Under-damped Harmonic Oscillator.

8: The optimization framework in claim 5, wherein the second constraint of the total three, based on the theory of Lyapunov Function, is provided to validate whether the candidate motion strategy can achieve the desired motion pose in time.

9: The optimization framework in claim 5, wherein the third constraint of the total three, based on the theory of Lyapunov Function, is provided to validate whether a candidate motion strategy can ensure a balance motion after achievement of desired pose.
